(19) United States
(12) Patent Application Publication
(10) Pub. No.: US 2013/0282154 A1
(43) Pub. Date: Oct. 24, 2013

(54) REMOTE DYNAMIC MESSAGE SIGN SYSTEMS AND METHODS OF CONTROL

(71) Applicants: Vere Chappell, Laguna Hills, CA (US); Kenton Krauss, San Diego, CA (US)

(72) Inventors: Vere Chappell, Laguna Hills, CA (US); Kenton Krauss, San Diego, CA (US)

(21) Appl. No.: 13/831,781

(22) Filed: Mar. 15, 2013

Related U.S. Application Data
(60) Provisional application No. 61/625,990, filed on Apr. 18, 2012.

(51) Int. Cl. G05B 15/02

(52) U.S. Cl. CPC G05B 15/02
USPC 700/90

(57) ABSTRACT

A system, method, and computer program product for controlling electronic signs remotely via one or more communication technologies are described. Content is identified, signs are selected, and the content is transmitted to particular signs from among a plurality of signs. Various forms of communication may be used, including cellular and satellite communications systems from a computer with access to the Internet.

### CROSS REFERENCE TO RELATED APPLICATIONS

This application claims priority under 35 U.S.C. §119(e) to U.S. Provisional Patent Application Ser. No. 61/625,990, filed Apr. 18, 2012, by Krauss et al., entitled REMOTE DYNAMIC MESSAGE SIGN SYSTEMS AND METHODS OF CONTROL, the contents of which are incorporated by reference herein in their entirety for all purposes.

### FIELD OF THE INVENTION

Disclosed herein are systems and methods for controlling electronic signs remotely via one or more communication technologies. In particular, disclosed herein are systems and methods for controlling Dynamic Message Signs (DMS) or other signs used for traffic control on highways and surface streets, and for controlling such signs via cellular and satellite communications systems from a computer with access to the Internet.

### BACKGROUND

Traffic control signs are often used to alert others of various conditions, including traffic conditions and emergency conditions. Other signs are often used to pass along various types of information to individuals. Typical control of these signs are often handled locally by a technician or other person who programs the signs. Coordinating messages among signs can be handled by multiple technicians at the same time, or by one technician over a long period of time needed to travel from sign to sign.

The above and other approaches are inefficient and costly. Moreover, the approaches lack infrastructure to provide real-time monitoring of signs by few individuals, on-demand changes to a network of signs, an ability to change a sign's message from anywhere remote from the sign, and other desired capabilities.

Accordingly, there is a need in the art to address the above-described as well as other problems.

### SUMMARY

This disclosure relates generally to systems, methods and computer program products for controlling electronic signs remotely via one or more communication technologies.

Aspects of the disclosure may provide a system, method and computer program product comprising various functional features, including functions that: identify a first indication of a first selection identifying a first remote sign from among a plurality of other signs; identify a first request associated with the first remote sign; cause first transmit data to be transmitted to the first remote sign based on the first selection and the first request; and identify first response data transmitted from the first remote sign, wherein the first response data relates to the first transmit data.

The functional features may also cause a user interface operated by a user to display a representation of the first response data, wherein the first response data indicates that the first remote sign is displaying the first message.

The functional features may cause the user interface to display an indication that the first data has been transmitted to the first remote sign prior to causing the user interface to display the representation of the first response data indicating that the first remote sign is displaying the first message.

The first selection may be a user selection of a first icon from a map of icons corresponding to the first remote sign and the plurality of other signs, wherein the map is displayed on the user interface.

The first request may include first message data representing a first message, and the first transmit data may include a representation of the first message data. The functional features may identify one or more message constraints associated with the first remote sign; and cause the first message data to be modified based on the one or more message constraints, wherein the first transmit data includes a representation of the modified first message data, wherein the one or more message constraints specify a maximum number of characters that the first remote sign can display, wherein the first message data specifies a first number of characters that is greater than the maximum number of characters, and wherein the first message data is modified to specify the maximum number of characters

The functional features may identify one or more message constraints associated with the first remote sign; and cause the first message data to be modified based on the one or more message constraints, wherein the one or more message constraints specify an available format type selected from the group of format types consisting of a maximum number of lines per page the first remote sign can display, a maximum number of pages the first remote sign can display, a maximum character width of each line the first remote sign can display, whether the first remote sign is capable of displaying streaming text, whether the first remote sign is capable of displaying colors, and whether the first remote sign is capable of displaying animation, wherein the first message data specifies a first format, and wherein the first message data is modified to specify the available format type.

The first transmit data may include a request for status information. The first response data may specify an orientation of the first sign and both latitude and longitude position coordinates of the first sign, or may specify one or more atmospheric conditions at or near the first sign, including one or more of temperature, barometric pressure, moisture, and wind power and direction.

The first request may specify requested information associated with the first remote sign, and the functional features may further: determine whether the data source has stored information specifying the requested information; determine, if the data source has the stored information specifying the requested information, whether the stored information is expired; upon determining that the stored information is not expired, cause the stored information to be transmitted; upon determining that the stored information is expired, cause the first transmit data to be transmitted to the first remote sign, wherein the first transmit data includes a representation of the first request; identify, from the first response data, response information specifying the requested information; cause the data source to update the stored information with the response information; and cause an expiration time associated with the stored information to update based on the updating of the stored information with the response information.

The first request may include a first data object value, and the functional features may store the data object value in the data source; cause the first transmit data to be transmitted to the first remote sign, wherein the first transmit data includes a representation of the data object value; identify, from the first response data, whether the first remote sign completed an update of a data object using the first data object value; and cause, if the first remote sign did not complete an update of the data object using the first data object value, the data source to remove the stored data object value.

The functional features may identify a second indication of a second selection identifying a second remote sign from among the plurality of other signs; cause the first transmit data to be transmitted to the first remote sign based on the first selection; identify second response data transmitted from the second remote sign, wherein the second response data relates to the first transmit data; and cause the user interface to display a representation of the second response data.

The functional features may identify second data transmitted from the first remote sign, wherein the second data indicates that the sign is moving; determine whether the movement of the sign is authorized or unauthorized based on data stored in the data source that indicates whether the sign is scheduled to be moved; and upon determining that the movement of the sign is unauthorized, causing an alert signal to be transmitted to a predefined user device.

A system may include a communication and control platform coupled to the first remote sign that comprises: a GPS tracking component configured to determine latitude and longitude of the first remote sign; a compass configured to determine an orientation of the first remote sign; a satellite network transceiver configured to receive the first transmit data from a satellite; a terrestrial network transceiver, wherein the first response data may be transmitted using the terrestrial network transceiver through the terrestrial network or the satellite network transceiver through the satellite network; and a processing component configured to process the first transmit data and to identify the first response data.

### BRIEF DESCRIPTION OF THE DRAWINGS

The present application may be more fully appreciated in connection with the following detailed description taken in conjunction with the accompanying drawings.

FIG. 1 shows a block diagram depicting a networked dynamic sign system for updating and storing dynamic sign data in accordance with at least one embodiment of the invention.

FIG. 2 shows an overview of hardware connected to the dynamic message sign which facilitates communication between the sign and the user remotely.

FIGS. 3A-B illustrate a process flow diagram detailing a process for caching dynamic message sign data to a database for future low latency access.

FIG. 4 illustrates a process flow diagram detailing a process for grouping individual related commands together for transmission to a dynamic message sign to optimize communications over a network.

FIGS. 5A-6C illustrate various user interfaces.

### DETAILED DESCRIPTION OF THE INVENTION

### Overview

Aspects and features of the current invention are designed to facilitate remote communications with a dynamic message sign via an internet-enabled device. Furthermore, the invention implements particular features to facilitate these communications in an optimized procedure designed to overcome the shortcomings of high latency networks, such as satellite.

As used herein, dynamic message sign may include any sign with a digitally-displayed message or image. Networks, as used herein, may include internet, cellular, satellite, or any other medium for transmitting data.

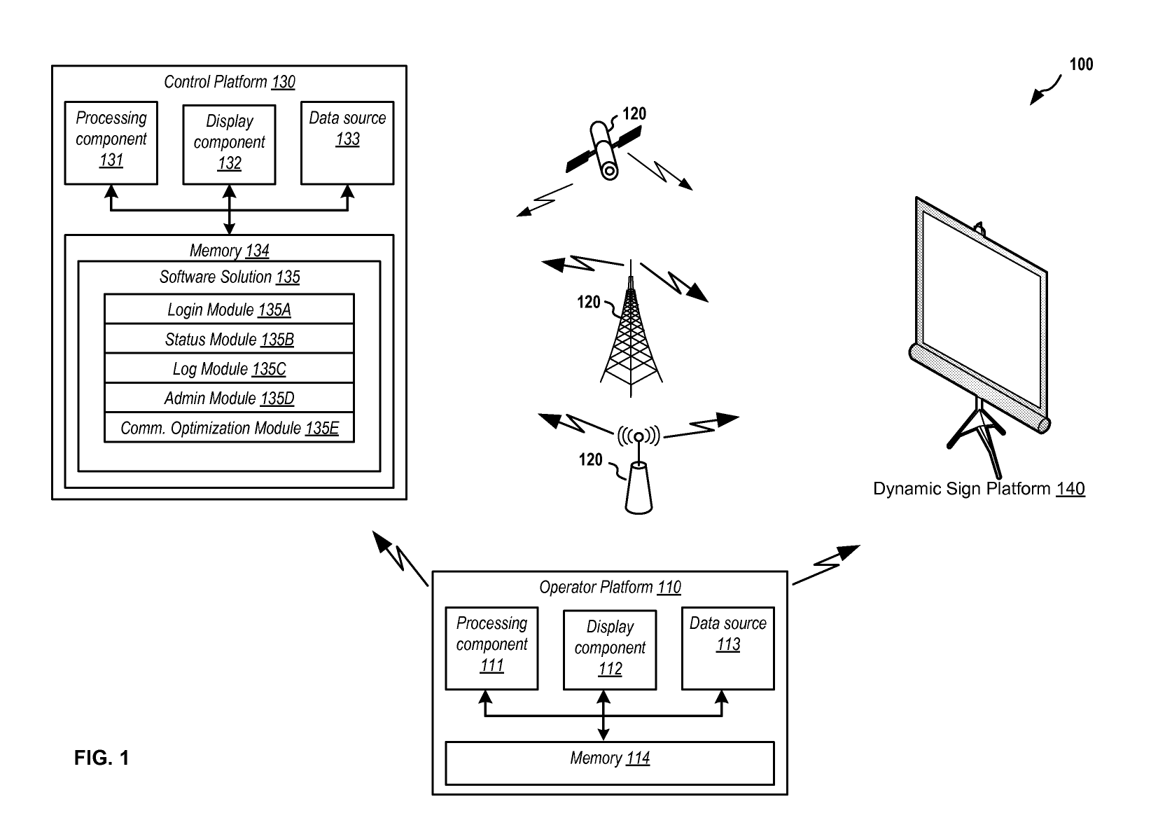

Generally, FIG. 1 shows an overview of the disclosed invention. An operator platform 110 may communicate with the control platform 130 over a communications network 120. These communications may include retrieving and displaying information pertaining to a dynamic message sign associated with the user. The control platform 130 may also communicate with the dynamic sign communications platform 140. These communications transmit user commands to the sign and may also retrieve data objects from the sign to return to a user. Alternatively, the control platform 130 may communicate directly with the dynamic sign communications platform 140 without use of the operator platform 110. Accordingly, a user may have full control over a number of individual dynamic message signs remotely without having to sacrifice reliability and accuracy.

### Operator Platform 110

The operator platform 110 may be used by a user in relation to certain embodiments of the invention, and may include any suitable computing device or combination of computing devices. Multiple operator platforms 110 may be used by multiple users. For example, the operator platform 110 may be any of numerous general purpose or special purpose computing system environments or configurations. Examples of well-known computing devices, systems, environments, and/or configurations that may be suitable for use with the implementations include, but are not limited to, personal computers, server computers, hand-held or laptop devices, multiprocessor systems, microprocessor-based systems, programmable consumer electronics, network PCs, minicomputers, mainframe computers, and distributed computing environments that include any of the above systems or devices, and the like. Accordingly, one or more aspects taught herein may be incorporated into a phone (e.g., a cellular phone or smart phone), a computer (e.g., a laptop or mini laptop), a portable communication device (e.g., “tablet” computing devices), a kiosk device, or any other suitable device that is configured to communicate via a wireless or wired medium. One or more aspects taught herein may also be incorporated into user input devices (e.g., keyboard, mouse, touch screen, speech recognition) or output devices (e.g., display, audio outputs).

As shown in FIG. 1, the operator platform 110 may include various components, including a display 111, a processor 112, a database 113, and memory 114 from which software may be executed (e.g., in a web browser). One of skill in the art will appreciate that the operator platform 110 may include addition components not shown, and/or may include only a subset of the components shown in FIG. 1.

### Communications Network 120

The communications network 120 may be any suitable type of network. The communications network 120 may be configured to provide communication links between the operator platform 110, the control platform 130, and the dynamic sign communications platform 140. Examples of communications links includes the Internet, private networks (e.g., virtual private networks or “VPN”s), local area networks (e.g., LAN, WiLAN, Wi-Fi, Bluetooth), cellular, satellite, other wireless communication pathways, and/or other wired communication pathways.

As those skilled in the art will appreciate, various intermediary network routing and other elements between the communications network 120 and the platforms depicted in FIG. 1 have been omitted for the sake of simplicity. Such intermediary elements may include, for example, the National Transportation Communications for ITS Protocol (NTCIP), the public switched telephone network (PSTN), gateways or other server devices, and other network infrastructure provided by Internet service providers (ISPs). In a preferred embodiment, the dynamic sign communications platform 140 may send and/or receive information (e.g., messages) via cellular and/or satellite connection(s). In particular, a user at the operator platform 110 may choose a preferred communication type (e.g., cellular or satellite), or the control platform 130 may set a communication type based on the user's choice or predefined settings, and the other communication type may be utilized as a backup method if the preferred communication network has failed or is otherwise inferior given different circumstances. For a cellular connection, the control platform 130 may connect to a cellular modem at the dynamic sign communications platform 140 via a predetermined IP address and port provide by a cellular carrier. On the other hand, the control platform 130 may communicate with the dynamic sign communications platform 140 using satellite. One skilled in the art will appreciate that messages sent to the dynamic sign communications platform 140 via an Iridium gateway may include at least two methods, Direct IP or Email. In each of the above communication methods, a message may be received at the dynamic sign communications platform 140, and the dynamic sign communications platform 140 may send a confirmation signal back to the control platform 130 or operator platform 110 via the control platform 130. Coding and decoding of messages will be understood by one of skill in the art.

### Control Platform 130

The control platform 130 of FIG. 1 is shown to include a processor 131, a display 132, a database 133, memory 134, and a software solution 135 including modules 135A-E. The database 133 is described herein in several implementations as a hard disk drive for convenience, but this is not required, and one of ordinary skill in the art will recognize that other storage media may be utilized without departing from the scope of the invention. In addition, one of ordinary skill in the art will recognize that the database 133 which is depicted as a single storage device, may be realized by multiple (e.g., distributed) storage devices. The database 133 may store data in a fixed file format, such as XML, comma separated values, tab separated values, or fixed length fields.

The database 133 may receive, store and send, among other data, data related to one or more user accounts (e.g., an entity possessing, using or otherwise controlling a dynamic sign from the operator platform 110). The database 133 may also receive, store and send data related to one or more dynamic signs (e.g., a dynamic sign communications platform 140). Such data is described in further detail below.

In accordance with certain aspects of the invention the control platform 130 may be configured to receive data from, send data to, and otherwise interact with the operator platform 110, using the communications network 120, to receive, analyze and process information from a user. For example, the control platform 130 may be configured to interact with the operator platform 110 to carry out certain functionality described herein including functionality related to identifying, tracking, and updating a sign's location and current state. Particularly, the control platform 130 may interact with the operator platform 110 to receive, analyze, process and/or store information input by a user at the operator platform 110. For example, user inputs may include selecting individual or groups of signs; inspecting and/or updating sign properties (e.g., identification information, sign type, etc.); polling one or more signs for status data (e.g., current message, pending message, power state, location, orientation, etc.); updating one or more signs with input generated by a user (e.g., new message, location, orientation, power state, etc.) and then storing the provided data to a centralized database 133; inspecting and/or updating sign or system properties (e.g., enabling/disabling sign features, status polling interval, communications protocols and associated settings, etc.); and investigating and troubleshooting of error or warning notifications (e.g., unexpected location or alignment, connection problems, temperature warnings, theft detection, hardware or software failures, etc.).

In a preferred embodiment a user may navigate a web interface at the operator platform 110 to view or update information at the control platform 130 pertaining to the user's dynamic signs over the Internet via a multi-threaded TCP/IP connection. The operator platform 110 may access the control platform 120 using a secure dedicated TCP/IP address and port. Once connected, a user at the operator platform 110 may use a graphic user interface to select a group of a particular type of sign (e.g., stationary) to view their current statuses. After a group of signs is selected, the operator platform 110 communicates with the control platform 130 to send and receive data such as sign name, current message, and/or location, and displays the information to the user in a stylized format in the web interface. The information displayed may either be data cached on the control platform's database 133 or polled in real-time from the sign itself. A user may then use the web interface to update the parameters of one or more signs remotely, such as updating a sign's message. For instance, a user may wish to change a stationary sign to indicate a new traffic pattern in response to an upcoming event in the area. Using the web interface, the user may easily input the new message, which is then transmitted to a centralized server at the control platform 130, stored on a database 133, and then coded and delivered to the sign (or any other NTCIP conformant device) using NTCIP standard commands. Consequently, the user is able to quickly and effectively change dynamic sign messages remotely without needing to be directly connected to the sign. The control platform 130 may also send information to the operator platform 110 for display, or otherwise communicated to a user. Such information may include sign identification numbers (e.g., make, model, and proprietary identification criteria), location and orientation information of a sign (e.g., including GPS coordinates) which may be displayed numerically or represented visually on a map, status information including real-time messaging, unexpected alignments or positions, and error messages, as well as other types of information stored at the control platform 130. In one embodiment of the invention, the information may be presented to a user using a web-based graphic user interface. The interface may communicate the information to a user using text, tables, maps, and/or graphic icons and ideally should be easily navigable and understandable. While identification and status information may be displayed to the user using text and tables, locations of particular signs may be visually rendered onto satellite images of a particular area. For instance, small icons indicating a sign's type and location may be overlaid on top of a collection of satellite images representing a local city. Further textual sign properties and status information may be displayed to the user by simply holding a mouse cursor over the sign's icon. Representing the sign locations in this manner may improve the user's ability to locate and control its dynamic message signs.

Furthermore, the control platform 130 may be configured to receive data from, send data to, and otherwise interact with the dynamic sign communications platform 140, using the communications network 120, to receive, analyze and process information from one or more individual dynamic message signs 160. For example, the control platform 130 may be configured to send and receive information and otherwise interact with the dynamic sign communications platform 140 (e.g., via the communications network 120 and/or the operator platform 110) to carry out certain functionality described herein, including functionality related to retrieving location and status information of one or more dynamic message signs or updating one or more dynamic message signs using data inputted by a user at the operator platform 110. Any data transmitted between the control platform 130 and the dynamic sign communications platform 140, as well as between the control platform 130 and the operator platform 110, may be cached in the database 133 and logged for further review by a user.

In one embodiment of the invention, the operator platform 110 may encode and transmit NTCIP dialog commands to the dynamic sign communications platform 140. Particularly, the control platform 130 may communicate wirelessly with communication hardware at the dynamic sign communications platform 140 using various communication devices, including a cellular modem and/or a satellite data terminal. The control platform 120 may send NTCIP dynamic message sign dialog commands, such as Simple GET, Simple SET, GET-NEXT Request, and Multi-part Dialog to the dynamic sign communications platform 140 via the communications network 120. These commands may be used to control the sign and retrieve up-to-date status information. The transmissions of such commands may be initiated by a user at the operator platform 110 or initiated by scheduled events at the control platform 130. After the control platform 130 determines that a NTCIP command is to be delivered to a particular sign, the control platform 130 may connect to the sign's hardware via the communications network 120, emulating a direct connection to the sign. The control platform 130 may encode the NTCIP command into a secure proprietary format, and then deliver the data via satellite or cellular networks to the sign's hardware. Once received, the dynamic sign communications platform (140) may decode the proprietary protocol and in turn communicate with the dynamic message sign using NTCIP conformant or compliant methods and protocols. Any return value requested of the dynamic message sign is similarly transmitted back to the control platform 130 and stored in a cache on the database 133 for future requests. The stored cache value may then be displayed, or otherwise communicated to, a user at the operator platform 110 using a web interface and a connection to the Internet as described above.

### Software Solution 135

As shown in FIG. 1, the control platform 130 may comprise a software solution 135 that includes a login module 135A, status module 135B, log module 135C, administration module 135D, and a communications optimization module 135E that are each implemented in software. The processor 131 may be coupled to various components, including the database 133, the display 132, and memory 134 (e.g., RAM, ROM). The processor 131 may be configured to execute instructions embodied in the software solution 135 stored on the memory 134. As described above, the database 133 may serve as a centralized data bank of data, including information regarding one or more users and one or more dynamic signs. One of skill in the art will appreciate that the software solution 135 may be configured to operate on personal computers (e.g., handheld, notebook or desktop) (not shown), servers (e.g., a single server configuration or a multiple server configuration) (not shown), or any device capable of processing instructions embodied in executable code. Moreover, one of ordinary skill in the art will recognize that alternative embodiments, which implement one or more components of the invention in hardware as detailed below, are well within the scope of the invention.

In one preferred embodiment, the software solution 135 may run as a web-based application on a device at the operator platform 110. The software solution 135 application may be compatible with any device that supports a standard web-browser, and preferably would exhibit the same appearance and functionality on each. For example, the software solution 135 may be executed by a web server which communicates with the operator platform 110 to display the software-based interface on a laptop, phone, tablet, desktop or other computer. A user at the operator platform 110 may interact with the software solution 135 via various features on the operator platform 110, including a web-based graphic user interface (“GUI”), to remotely modify and/or access the database 133 of the control platform 130, and to control any associated dynamic sign communications platforms 140. One skilled in the art will appreciate that many other various devices may be used to interact with the software solution 135 such as cell phones, smart phones, and any other device which supports a standard web browser. Alternatively, the software solution 135 and associated components (e.g., processor 131, display 132, database 133, and/or memory 134) may reside on the operator platform 110.

Attention is now drawn to modules 135A-E of the software solution 135. Modules 135A-E may operate in concert with each other to perform certain functions of the software solution 135. Software solution 135 may include a login module 135A, a status module 135B, a log module 135C, an administration module 135D, and a communications optimization module 135E. Each module 135A-E may be associated with one or more functions of the software solution 135 and a description of each is provided in terms of certain functionality below. Generally, the software solution 135 causes the generation of an interactive web page for display at the operator platform 110. However, one of skill in the art will appreciate the various ways in which such functionality can be embodied in source code or otherwise that provides for carrying out the functions of the modules described below.

### Login Module 135A

Login module 135A may be configured to carry out aspects associated with identifying users of the system and assigning each with different permissions accordingly. Identification may be achieved by providing users with unique username and password combinations. A user may only access further modules and components of the software solution 135 by correctly inputting the user's unique username and password using the operator platform 110. When an acceptable username and password is entered, the software solution 135 proceeds to the status module 135B, detailed below. However, if a user enters an unacceptable username and password, the login module 135A displays an error message and allows the user to retry inputting a valid username and password at the operator platform 110. After a selectable number of failed attempts, the login module 135A may lock the user's account and/or send a notification email to that user, an administrator, or another user indicating the failed attempts and a procedure for unlocking the account.

### Status Module 135B

Status module 135B may be configured to display, to a user of the operator platform 110, information regarding a user's associated sign(s) and respective locations of the sign(s) on in an interactive web page. Generally, the status module 135B causes to generate an informative interactive web page and may be organized as an overview of all signs associated with that user, all users or a subset of users, and may provide quick access to information pertaining to individual or groups of signs as well as facilitate any changes or updates to the signs a user wishes to make. The user may access the information for any associated signs by either selecting the desired signs from a list or by selecting the signs represented visually on a map according to their respective current locations.

In one preferred embodiment, the status module 135B generates an interactive map on a device at the operator platform 110 which displays the locations and status indicators of each of the user's dynamic signs. The map may include features such as pan and zoom and may include icons for roadways, cities or other mapped areas and things. Moreover, the geographic area may be represented as either a standard map or as satellite images provided by third parties (e.g., Google™ maps, Bing™ maps, or other map applications). Separate icons may be used to distinguish different types of signs, orientation of those signs, location of those signs, status of those signs, or operator of those signs.

Upon selection of an individual or group of signs by a user the status module 135B may cause the display of information regarding the selected signs at the operator platform 110 accordingly. The information may be gathered from the control platform 130 (e.g., from database 133), or possibly from the dynamic sign platform 140, and displayed to the user at the operator platform 110 via the web interface or other means. The particular information collected and displayed may differ for individual users, but may include sign identification information, message status (pending, active or blank), sign alignment and location details, error and warning status messages, and any other type of information gathered and stored at the control platform 130.

In another embodiment, the status module 135B generates a list for display at the operator platform 110. The list may catalog each dynamic sign associated with a user. The user may sort or filter the list based on several criteria as outlined herein. Once properly formatted, the list may be used by a user to gather and update dynamic sign information. For instance, a user may wish to check the status of a particular sign identified on the list displayed via the web interface. After selecting a desired sign from the list, the status module 135B may populate the web interface with the available information. A user may check the current status of a particular dynamic sign by polling the dynamic sign platform 140 and refreshing the information currently stored in the database 133. The status module 135B may generate an indication confirming communication received from the dynamic sign platform 140 and the data received is stored and logged in the database 133.

Furthermore, status module 135B may be configured to allow a user to update information on the sign remotely using the operator platform 110 through a web interface via the communications network 120. In one embodiment, a user may access the web interface to change or update a sign's message, put the sign in a low power mode, and may even provide for error troubleshooting and resolution. Status module 135B may generate a preview of the sign's pending message at the operator platform 110 in a form representative of how the message would appear on the respective sign.

For example, in one embodiment a user may wish to change a message on an individual or group of signs located in a certain area. After selecting the signs from a map generated by the status module 135B, a user may input a new message remotely via the operator platform 110. Prior to updating all of the dynamic signs, the status module 135B generates a preview of how the message may be displayed on each of the selected signs. Once the message format is confirmed by the user, the status module 135B initiates communications between the control platform 120 and the dynamic sign communications platform 140 over communications network 120, and causes each sign to update to the message. A confirmation message may then be sent by each dynamic sign communications platform 140 associated with each sign to confirm that each sign has been correctly updated with the message.

The status module 135B may be further configured to maintain the centralized database 133 of information on every sign in the system. For instance, the status module 135B may record and track several types of information like sign identification, sign type, current state, location, communications antenna information, and other relevant information to each dynamic sign. Furthermore, the database 133 may maintain user-related information including name, usernames and passwords, time zones, and sign assignment. The status module 135B may keep the centralized database 133 sufficiently updated by polling each dynamic sign on a regular basis (e.g., daily), or after instructed to poll a sign, and then causing the database 133 to store the information. When polling a sign, a poll request may be sent to the sign, which retrieves the sign's current message, and confirms its geographic placement (e.g., on a digital representation of a map). This feature is advantageously used when setting up or relocating a sign.

### Log Module 135C

Log module 135C may be configured to collect some or all information (e.g., messages) sent to and received by any of the platforms 110, 130 and 140. The log module 135C may be further configured to cause the database 133 to store the information, and may also be configured to cause the display of these messages to the operator platform 110. Such information stored in the database 133 may include but is not limited to date and time, sign and user identification information, sign name, event type, and event details. The log module 135C may be designed to display the information to the user of the operator platform 110 in any understandable format such as a list and may be easily sorted or filtered by information such as type of event, sign, or date of event. The log module 135C may also include a feature to automatically refresh the log with any recent activity not already displayed to the user. The log module 135C may also feature an export feature to allow a user to print the current report to a file on the operator platform 110 or to an attached printer.

### Administration Module 135D

Administration module 135D may be configured to facilitate management of several aspects of the system. Generally, the administration module 135D may generate a web page, viewable on a web-browser at the operator platform 110, whereby an administrator may organize the system as a whole and manage those who may access it. The administrator may utilize the generated web interface to make changes to the control platform 130 or dynamic sign communications platform 140. Information entered into the web interface may be transmitted to the control platform 130 and stored on the database 133. Furthermore, the entered information could be transmitted to the dynamic sign communications platform 140 to update the information for each individual sign.

In particular, an administrator may utilize the administration module 135D to add information regarding a new sign, update the information of a sign, or delete information of a sign. Furthermore, the administrator may view or edit sign characteristics such as location, online or offline status, communications protocol, automatic polling intervals for particular signs, and many other pertinent features. The administration module 135D may also be used to assign one or more signs to a particular group as desired by the administrator or other user. Additionally, the administration module 135D may allow an administrator to add, remove, and otherwise control who may access the control platform 130 and/or the dynamic sign communications platform 140, and set privileges according to the desired access of each individual user at the operator platform 110. Finally, the administration module 135D may provide parameters for different communications methods (i.e., satellite, cellular, Internet) and allow modification of the associated values (i.e., port numbers, IP addresses, email addresses) by a user.

### Communications Optimization Module 135E

Information exchange between the platforms 110, 130 and 140 may be controlled by communications optimization module 135E residing at the control platform 130. The communications optimization module 135E controls the exchange of data and provides a gateway through which a user may securely control any NTCIP conformant device (e.g., including a dynamic message sign) remotely, for example, by using a web-browser enabled device (e.g., the operator platform 110). The communications optimization module 135E may provide a user with many features including simultaneous tracking and updating of multiple dynamic message signs; multiple connection methods (e.g., Cellular, Satellite, Email, Direct IP, etc.) with automatic failover (e.g., wherein one connection method may be used for a first transceiving attempt, and another connection method may be used for a second transceiving attempt); automatic message retransmission and failure reporting; integrated logging and storage of sign data, error messages, and other system events and data; and access to dynamic message sign configuration remotely in an interactive and secure environment.

In controlling the exchange of data throughout the entire system, the communications optimization module 135E may encode NTCIP commands and responses to provide robust and secure wireless transmissions. In one embodiment, the communications optimization module 135E may encode certain NTCIP dialog types, such as simple GET, simple SET, multi-part dialog, and get-NEXT requests. For example, a user may send a command to the control platform 130 requiring one of the above NTCIP commands to be sent to a dynamic message sign. The communications optimization module 135E may then emulate a direct connection to the dynamic message sign over a secured wireless communication network, convert the NTCIP command into another format for transmission, and transmit the command over a wireless communication network to the dynamic message sign. Once received, the NTCIP command is converted back into its original format and executed by the dynamic message sign. If any return value is requested, the communications optimization module 135E similarly packages the return data for transmission to the operator platform 110 and the control platform 130. The retrieved value may also be cached at the control platform 130 to satisfy future requests. For some commands, such as multi-part dialog and get-next requests, the communications optimization module 135E may control how a number of commands are to be transmitted between the dynamic message sign and the control platform 130. For example, a user input may require a series of commands as part of a defined NTCIP dialog command at the dynamic message sign. Here, the communications optimization module 135E may delay connecting to the communication hardware until the entire series of commands may be delivered as a single message to the dynamic message sign. On the other hand, GET-NEXT requests from the communications optimization module 135E similarly may be utilized to retrieve multiple consecutive requests for dynamic message sign objects from the dynamic sign communications platform 140.

Beyond merely facilitating the data exchange between the platforms 110, 130 and 140, the communications optimization module 135E may also incorporate several features to optimize the communication pattern over the communications network 120. These features may help to mitigate any latency or reliability issues known when using wireless networks such as satellite and cellular.

In one embodiment, the communications between the platforms 110, 130 and 140 may be optimized to overcome difficulties with certain types of communications networks. For example, the system may relay communications between the platforms 110/130 and 140 over a satellite messaging system, unlike a traditional implementation which uses point-to-point communications directly between the platforms. Consequently, the use of satellite communications may introduce unavoidable latency each time a message is relayed between the platforms 110/130 and 140. To mitigate the impact of this latency, an embodiment of the present invention may incorporate several features designed to optimize satellite communications between the platforms 110/130 and 140 by reducing the number of individual messages required to perform individual tasks. For example, an NTCIP dialog to define a message to be displayed on a sign may involve ten round-trip messages relayed to and from platform 140, including seven SET commands and 3 GET commands. However, certain embodiments may accomplish the control of the dynamic message sign using less command messages, including an embodiment using only a single message instead of the usual ten commands.

In particular, the embodiment described above may be achieved through caching the objects returned by the commands to the control platform 130 by storing on the database 133. For example, the communications optimization module 135E may maintain a table in the database 133 of all NTCIP objects and selected NTCIP global objects for dynamic message signs (i.e., NTCIP 1203 v.2.35 and NTCIP 1201 v.3.03) which may be required to support dynamic message sign operation. For each object associated with every individual dynamic message sign, the table may indicate whether the object may be cached or not in a data source, and if so, how long it should remain cached before expiring. These parameters may be pre-set according to analysis of the requirements for proper dynamic message sign operation. For example, objects in the table that reflect real-time status of the signs may be designated to not be cached, whereas objects which reflect static information about a dynamic message sign may be designated to be cached indefinitely. The database 133 may hold a separate table of cached values for each dynamic message sign maintained by the control platform 130.

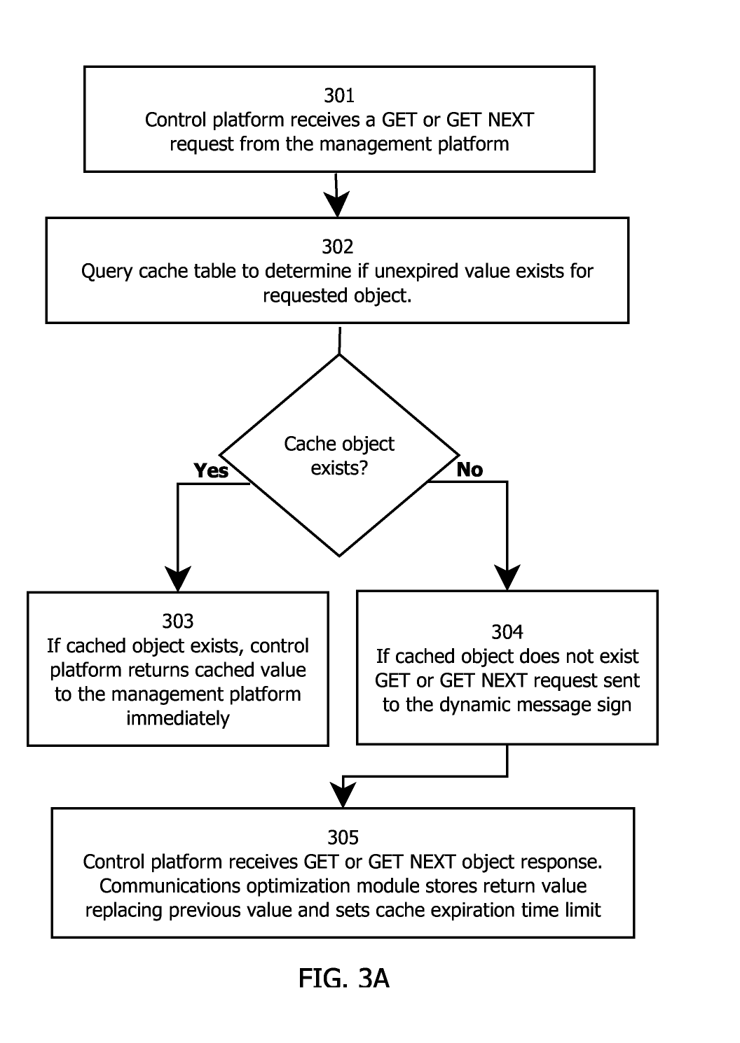

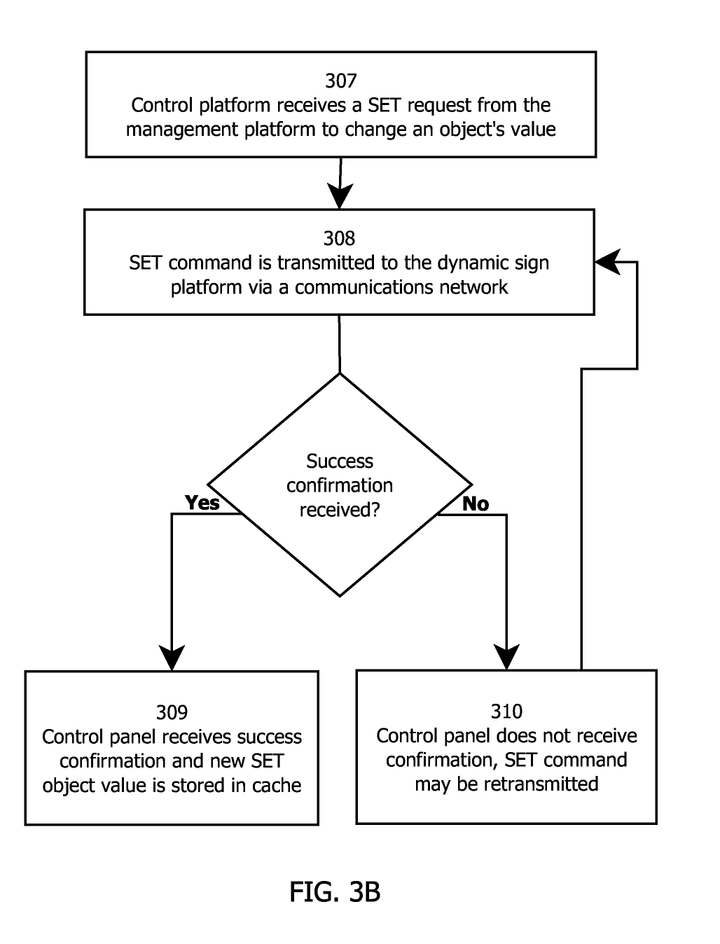

In one embodiment, the caching feature of the control platform 130 may be implemented in accordance with FIG. 3. First, at Step 301, the communications optimization module 135E may receive a GET or GET-NEXT request from the operator platform 110. Following receipt of the command, the communications optimization module 135E queries the appropriate cache table to determine if there is an unexpired value cached for the particular object at Step 302. If an appropriate cached value, which is unexpired, exists in the table, the control platform 130 returns this value to the operator platform 110 immediately without querying the information from the dynamic message sign at Step 303. However, if object requested is expired or has been designated to not be cached, the GET or GET-NEXT request may be relayed to the dynamic message sign at Step 304.

At Step 305 the communications optimization module 135E may receive GET or GET-NEXT response from a dynamic message sign at the dynamic sign communications platform 140. At Step 306 the communication optimization module 135E may store the return value in the cache, replacing any previously cached value, and may reset an expiration time limit for the cache value according to a designation in the master NTCIP object table.

Moreover, at Step 307 the communication optimization module 135E may receive a SET request from the operator platform 110 to change a value (e.g., sign message, etc.) at the dynamic message sign. Accordingly, at Step 308 the SET command is transmitted to the dynamic message sign using the communications network 120. Before storing the value in the cache, however, the control platform 130 may wait to receive confirmation from the dynamic sign communications platform 140 that the object has been successfully transmitted and set at the appropriate dynamic message sign during Step 309. Where a required confirmation is not received, the object may not be recorded in the cache and the SET command may be retransmitted to the dynamic message sign until a valid confirmation is received by the control platform or a maximum number of attempts is exhausted at Step 310. If an error is returned for any operation on any object, the value of that object may be cleared from the cache. If the communication optimization module 135E invokes a dialog, as outlined below, all objects that are to be set as a result of the dialog may first be cleared from the cache.

In yet another embodiment, the communications optimization module 135E may group NTCIP commands into dialogs for accomplishing dynamic message sign tasks, such as defining the message on a sign. Each dialog is a sequence of GET and SET commands that are followed in a predetermined order to accomplish the task. Recognition of these particular dialog tasks allows the communications optimization module 135E to determine that a particular dialog is being performed after only the first one or two requests have been received by the control platform 130. When the communications optimization module 135E recognizes that the operator platform 110 is performing a predetermined dialog, it responds appropriately to the commands sent by the operator platform 110 and begins constructing a special dialog request for the dynamic sign communications platform 140. For example, if several SET requests are involved in a particular dialog, the communications optimization module 135E accepts each request from the operator platform 110 but groups them all together to send in the dialog message to the dynamic sign communications platform 140. Similarly, if multiple GET requests are involved in the dialog, the communications optimization module 135E returns the expected values directly to the operator platform 110 in order to continue the dialog. Once all components of the dialog have been received from the operator platform 110, the dialog message is transmitted to the dynamic sign communications platform 140, which executes the dialog directly with the dynamic message sign, as a proxy for the operator platform 110. The results of the dialog are then returned to the control platform 130, which returns the final results to the operator platform 110.

Various dialogs may be supported in a particular embodiment in accordance with the invention including: retrieve and store a sign information (e.g., type, height and width, location, housing climate (e.g., humidity, temperature, etc.), status, power use, power level); retrieve and store font information (e.g., size, height, width, content/character, type, number, line spacing, status); retrieve and store a font or graphic information; delete a font or graphic; configure light output algorithm; activate a message; define a message; define a schedule; execute pixel testing; monitor power error details; monitor current message; define a time-base schedule; retrieve external climate information; retrieve video from camera coupled to sign; and others.

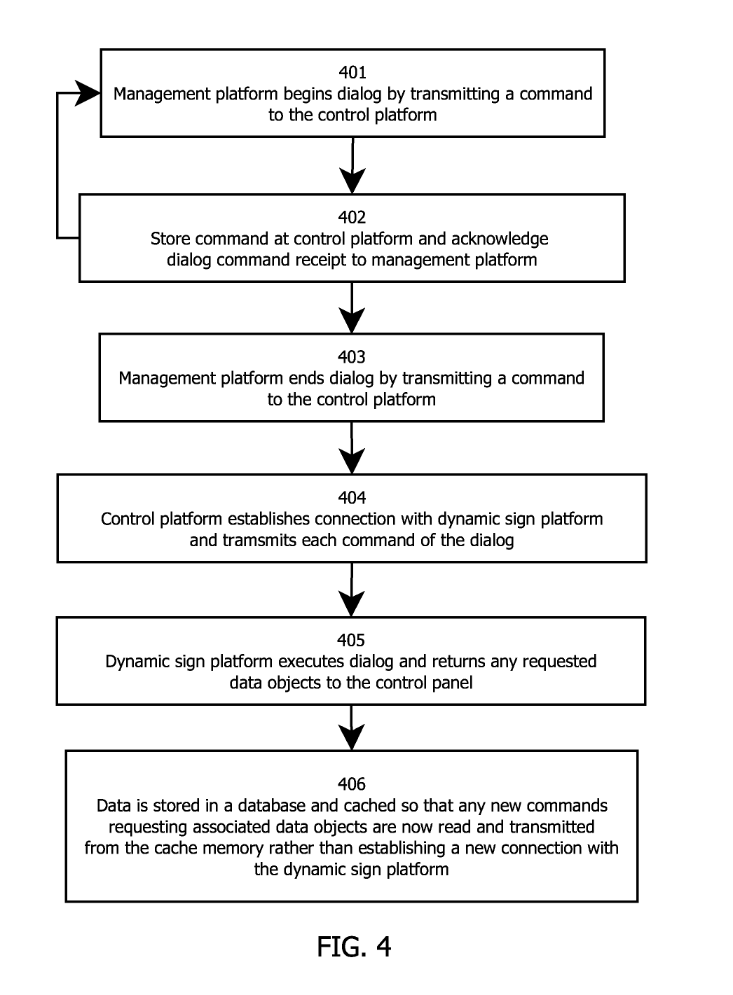

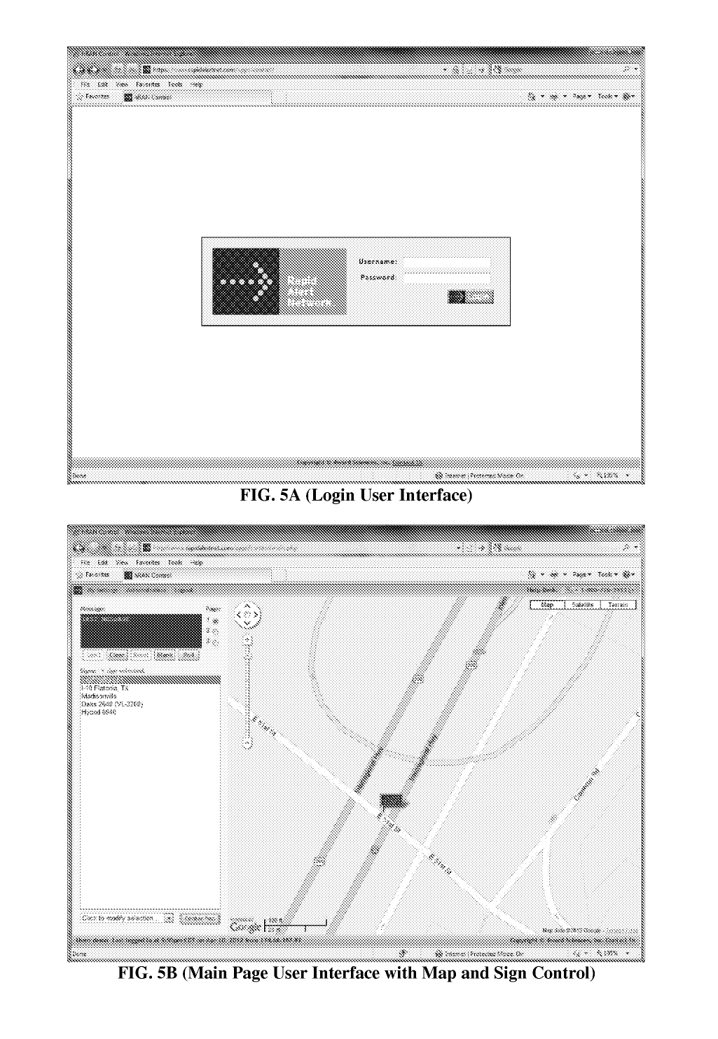

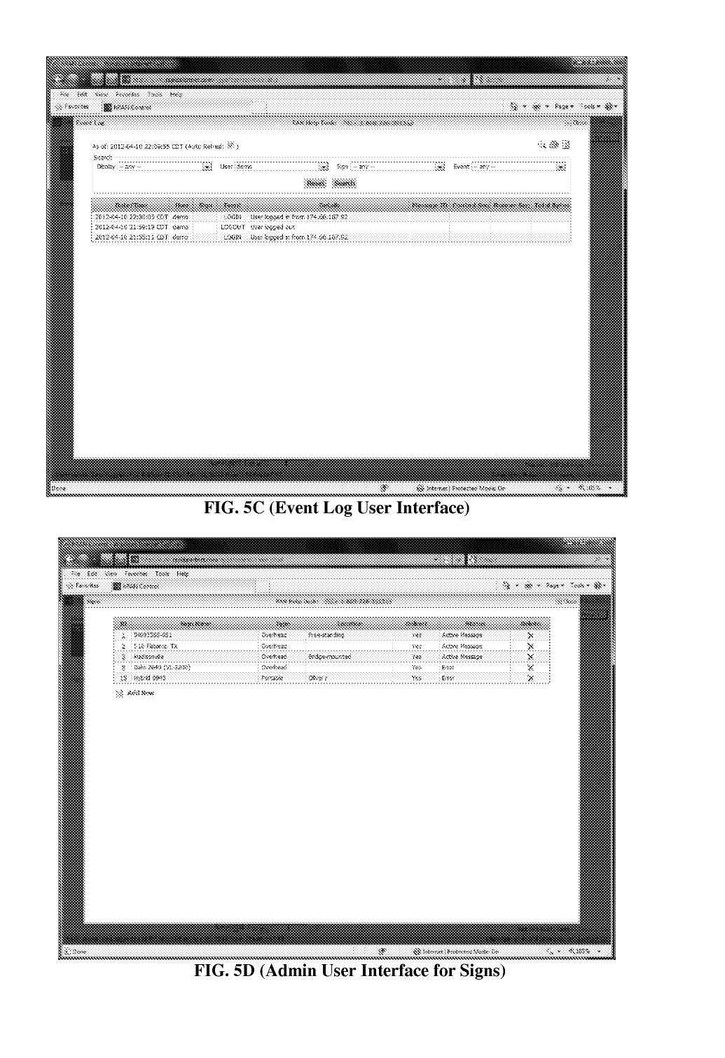

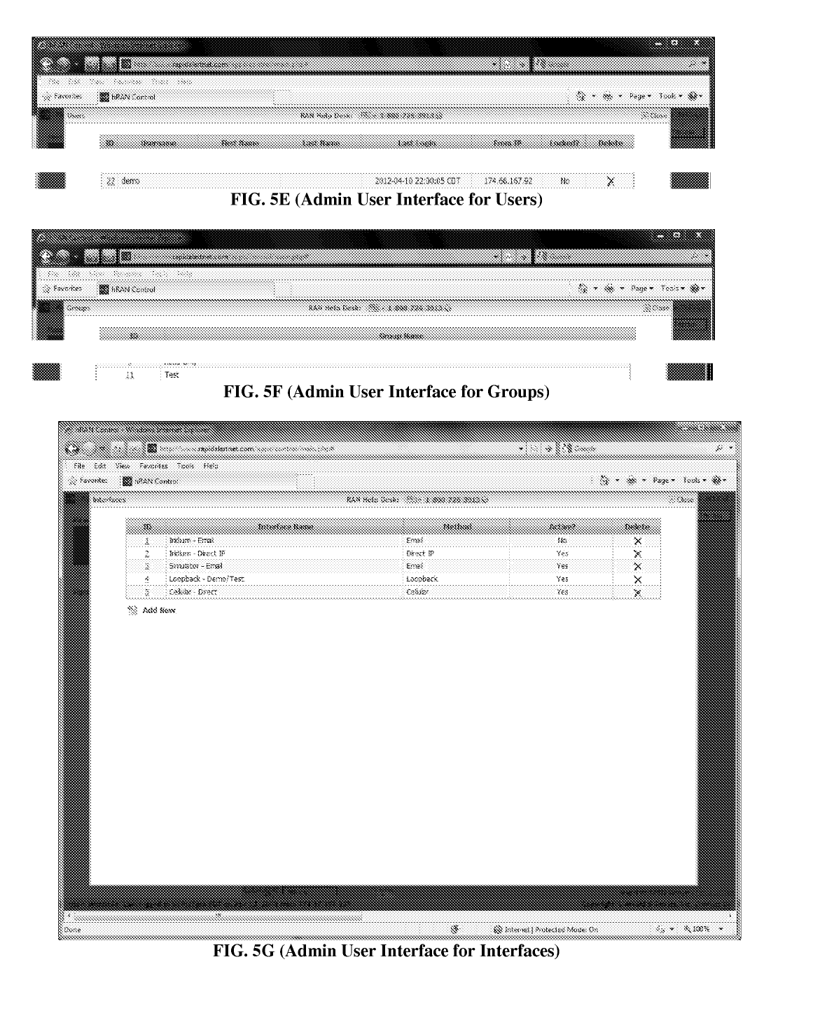

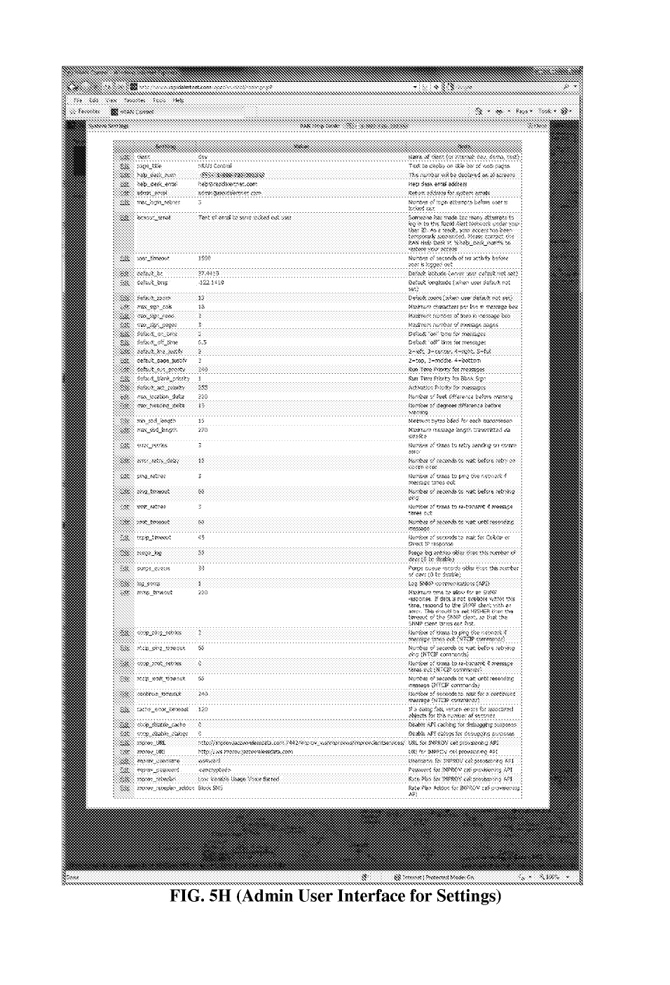

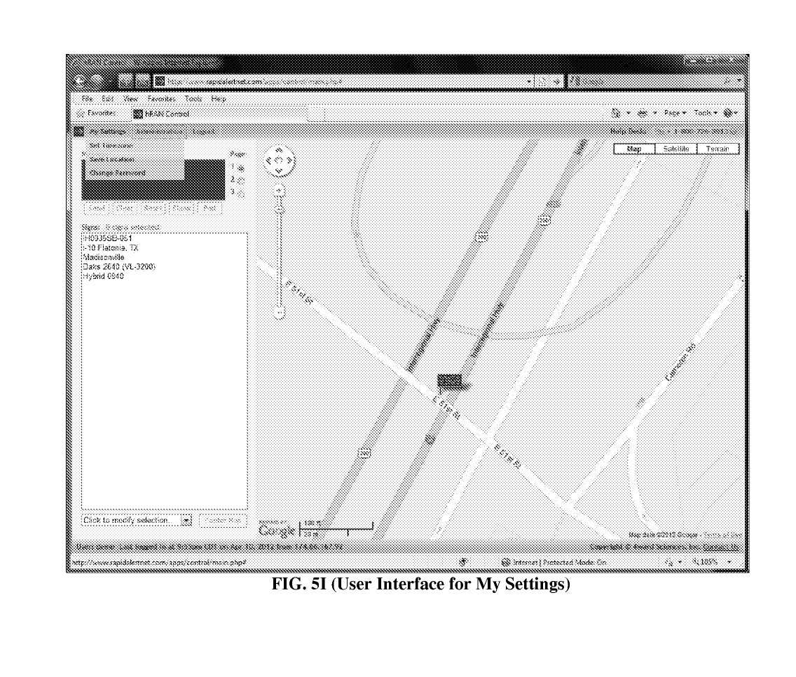

For example, FIG. 4 may describe the operational steps of the NTCIP dialog for defining a message on a dynamic message sign. First, at Step 401, the operator platform 110 may send a command (e.g., SET dmsMessageStatus to “modifyReq”) to begin the message modification dialog. In response, the control platform 130 stores the dialog command and may return a notification to the operator platform 110 (e.g., a notification that the control platform 130 received the command) at Step 402. Next, the operator platform may send another command (e.g., GET dmsMessageStatus) to indicate to the control platform 130 the current status for the sign's message at Step 401. Again, the control platform may return an indication that it has received this message and is preparing for the rest of the dialog (e.g., return “Modifying”) at Step 402. The operator platform 110 may also send several commands to set specific objects on the dynamic message sign (e.g., Set dmsMessageMultiString to “New Message”, SET dmsMessageOwner to “New Owner”, SET dmsMessageRunTimePriority to priority setting). However, rather than send each of these commands individually to the dynamic sign communications platform 140, the communications optimization module 135E stores each of these values in the database 133 and may respond to the operator platform 110 with an indication of receipt at Step 402. At Step 403, the operator platform 110 may send a command to indicate that all of the commands for the particular dialog are completed (e.g., SET dmsMessageStatus to “validateReq”).

At Step 404, the communications optimization module 135E may send the entire dialog message to the dynamic sign communications platform as a single message containing the changes to the message, owner, and priority objects. In return, the dynamic sign communications platform 140 may store the objects in memory at the platform 140, and may return a message which includes commands indicating that the dynamic message sign has received and executed the commands properly (e.g., dmsMessageStatus and dmsValidateMessageError) at Step 405. Upon a successful execution by the dynamic sign communications platform 140, the communications optimization module 135E stores the values in the cache and may return an indication of success to the operator platform 110 if successful at Step 406. Afterwards, the operator platform 110 may request the message status or errors and the values stored in cache at the control platform 130 may be returned instead of connecting to the dynamic sign communications platform 140 again.

In the above example, repetitive Steps 401-403 occur entirely between the operator platform 110 and the control platform 130 with very low latency because no message needs to be sent to the dynamic sign communications platform 140. At Step 404, when the operator platform 110 sends the final SET command to the control platform 130, the control platform 130 establishes a connection with the dynamic sign communications platform 140 and sends the entire dialog which was stored on the database 133. Moreover, after a successful execution at the dynamic sign communications platform 140 of the dialog, the results are cached for future requests. Any future requests involve low latency connections because they are fulfilled directly from the cache.

In another embodiment, the communication optimization module 135E may also use grouping to further enhance optimization on high latency networks (e.g., satellite). Generally, when the value of an NTCIP object is requested using a GET or GET-NEXT command, often the value of other related objects may be requested in subsequent requests. For example, if a short error status object (e.g., ErrorStatus) is requested, typically other related objects (e.g., dmsActivateMsgError, dmsMultiSyntaxError, dmsMultiSyntaxErrorPosition, etc.) may also be requested by the operator platform 110. The communication optimization module 135E may anticipate such requests by maintaining a table of NTCIP objects that are likely to be requested consecutively. This table may either be static, modifiable by an administrator, or dynamic, actively “learning” repetively grouped commands as they are executed by the control platform 130. For example, the communications optimization module 135E may receive a GET or GET-NEXT command from the operator platform 110 and, using the grouping feature, the communications optimization module 135E may reference the master NTCIP grouping table to include all related objects requests in a single transmission to the dynamic sign communications platform 140. When the values are returned by the dynamic sign communications platform 140, the values may then be automatically cached into the database 133. Then, if subsequent GET or GET-NEXT commands are received from the operator platform 110 requesting these objects, the values may be returned immediately to the operator platform 110 using the cached values from the database 133, eliminating the need for another transmission to the dynamic sign communications platform 140. Therefore, much fewer communications may be required increasing the efficiency and speed of the system even when using a high latency network such as satellite.

Any of the above embodiments of the communications optimization module 135E may be combined wholly or partly with any other features including those not described herein. Each may be controlled according to settings in the database 133, and thus may be readily adjusted by an administrator as needed to meet the requirements of a particular implementation.

Data communicated between the platforms 110-140 and stored or cached in the database 133 may have many different functions, formats, and other characteristics. Data strings may specify various fields in the database 133. For example, the functionality for the GET DMS Object specified by various fields for a particular embodiment regarding messages transmitted between the control platform 110 and the dynamic sign communications platform 140 may be defined by: Duration (2-byte integer); Activate Priority (1-byte integer); Message Memory Type (1-byte integer); Message Number (2-byte integer); Message CRC (octet string of length 2); Source Address (octet string of length 4). Each of these data fields relates to separate functionality: Duration may indicate how long the message is to remain active; Active Priority may indicate the message's priority; Message Memory may represent the type of memory to which the message is to be stored within the sign's firmware; Message Number may indicate a particular message when multiple messages are available; Message CRC may be a value to determine if there have been any transmission errors; and Source Address may be an indication of where the transmission originated. Additionally, some data types may use strings to indicate information such as the text of a message to be displayed, the name of a font stored in the sign's memory, or the sign's firmware version name. Multiple data strings may be used to convey individual information where that length of information exceeds a maximum length of the string or a field within the string. Each command (e.g., GET DMS Object, SET DMS Object, EXECUTE DMS Dialog, etc.) may share similar data fields but may also have fields relating to a particular command.

In each embodiment, the data structures may follow rules or may be required to conform to a format determined by an administrator. For example, an Object ID field may always be followed by a data type and a non-empty data field. Further, integer data and numeric data represented as a sequence of octets may be in unsigned hexadecimal format. Each half-byte (nibble) may be represented by a hexadecimal digit, to include leading zeroes where appropriate (e.g., the decimal value 10 may be formatted in hex as “0A” (1-byte integer); the decimal value 256 may be formatted in hex as “0100” (2-byte integer), and the decimal value 65536 may be formatted in hex as “00010000” (4-byte integer). Similarly, when an Object ID in the Execute DMS Dialog commands specifies a read-only object, or when a read/write object is specified and the object is to be retrieved (i.e., via GET command), the data field may be populated with a single space character between delimiters. Also, when object data is SET by a dialog, integer data and numeric data represented as a sequence of octets may be in unsigned hexadecimal format.

Regarding a DMS Dialog Response, the sequence number may match the sequence number of the corresponding dialog message. Also, the Dialog Status field may contain the following, representing the status of the SNMP transaction(s) with the dynamic sign: 0-No Error; 1-Response Too Big; 3-Data Type Invalid; 4-Read Only; 5-General Error. Similar to Table 3, the Object ID field may be followed by a data field. If the data is null or missing, it may include a placeholder delimiter. Finally, if the total size of the dialog response would exceed the maximum message length, it may be split into multiple dialog responses such that the maximum length is not exceeded. All dialog responses to a single dialog request may have the same sequence number.

Similar rules regarding the data structures of communications between the platforms 110-140 may apply to all of the commands transmitted between the operator platform 110, control platform 130 and dynamic sign communications platform 140, as well as for data structures in other embodiments. One skilled in the art will recognize the many different ways that data may be organized and transmitted over the communications network and the countless formatting requirements each may require.

### Dynamic Sign Communications Platform 140

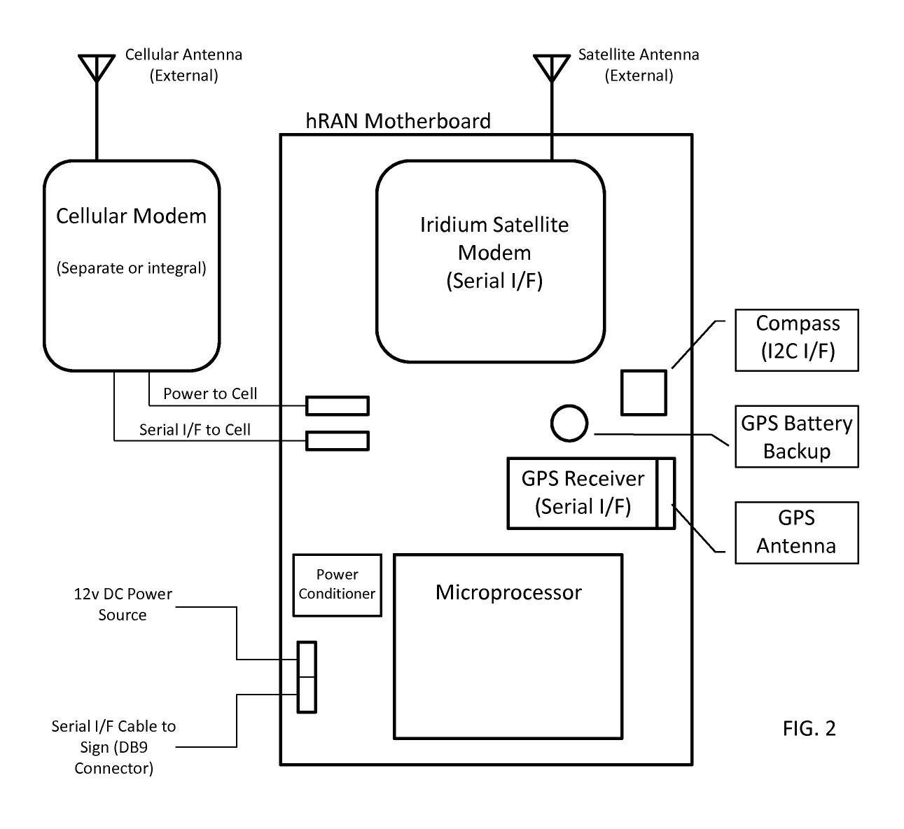

The dynamic sign communications platform 140 of FIG. 1 may be configured to communicate with the control platform 130 and operator platform 110. The dynamic sign communications platform 140 may consist of communications hardware enclosed in a single weather proof enclosure mounted to the top of each dynamic message sign as shown in FIG. 2 at 201. The communications hardware may then be directly connected to a dynamic message sign to allow the communications hardware to send and receive messages to and from the sign and receive power. Generally, the dynamic sign communications platform 140 receives and sends data with the control platform 130 to either update the message or settings on a dynamic sign or to track the current status of the dynamic sign.

For example, in one embodiment the communications hardware may interface with the dynamic message sign via a customized cable utilizing the RS-232 serial protocol to exchange data with the sign 207. Additionally, the customized cable may include wiring for providing power to the communications hardware from the sign's power source (e.g., solar cells, DC power, AC power) and may also include protection against voltage spikes and other electronic phenomenon which can damage the electronics 207. Alternatively, power may be provided to the communications hardware via a power source independent of the dynamic message sign (e.g., AC adapter, vehicle battery, solar cells, wind power or any other power generator). A second RS-232 serial port may be added to preserve manual control of the sign by a user on-site.

To perform the various tasks required the communications hardware may include a controller printed circuit assembly which may accommodate a microcontroller 205; an Iridium data terminal 202; a GPS receiver 204 (e.g., to determine where a sign is located and if the sign has moved); a magnetic compass sensor (e.g., solid-state magnetometer) 203 (e.g., to determine orientation of the sign relative to a fixed point like a lane of a road); and power conditioning electronics 206 mounted to a four layer printed circuit board (PCB). A cellular modem 210 may also be mounted on the printed circuit board or alternatively included within the communications hardware housing as a stand-alone device connected to the main circuit via a serial and power cable. In one typical embodiment, a sufficient microcontroller may have the following specifications: 58.98 megahertz (MHz) CPU Clock Frequency; 512 kilobytes (KB) of Data SRAM; 512 KB of Program Execution Fast SRAM; 1 megabyte of Serial Flash memory; Removable SD or microSD card memory up to 2 gigabytes (GB) for storing the program initialization file; and an Ethernet port. Moreover, the microcontroller may need to withstand a wide range of operating temperatures (e.g., −20C to 85C) and humidities (5% to 95% relative humidity).

### Initialization at Dynamic Sign Platform 140

The Dynamic Sign Platform 140 includes an electronics enclosure containing, among other components, a remote satellite terminal, cellular modem, a microprocessor, a printed circuit board, a GPS receiver, compass, and the microprocessor firmware to control the components and communications. The enclosure may be mounted to the structure of a sign, and connected to the sign's serial port as well as a power supply to facilitate changing the sign's messages via a web-based or other interface.

The Dynamic Sign Platform 140 enclosure should be securely mounted to the portable or overhead sign structure using the mounting hardware. To the greatest extent possible, the enclosure should be mounted with a clear and unobstructed view of the sky. In particular, satellite communications are adversely affected by overhead obstructions that prevent a “line of sight” path to the satellite(s) that are in view. When signs are placed in urban canyon environments, terrestrial communications (e.g., cellular) or wireless web-based communications (e.g., Wi-Fi, Bluetooth) may be used.

For portable signs in particular, the Dynamic Sign Platform 140 enclosure should be mounted with its base facing downward, parallel to the ground plane. Sideways or off-angle mounting may cause the compass to report inaccurate information, and adversely affect the ability to detect unauthorized movement of the sign. Other inertial and orientation sensors may also be used, including gyroscopes and accelerometers.

The Dynamic Sign Platform 140 may connect to a sign via a standard DB-9 serial cable. In accordance with certain aspects, a sign's communication parameters should be set to the following values for successful communications with Dynamic Sign Platform 140: 9600 Baud; No Parity; 8 Data Bits; 1 Stop Bit; Flow Control OFF.

The Dynamic Sign Platform 140 may be powered either by a portable sign's 12V battery, or for overhead signs supplied with 110V AC power, by an appropriate 12V power adapter. Additional power sources may include solar and/or wind power sources.

The Dynamic Sign Platform 140 may have a single dual-sided LED which is visible on the enclosure and illuminates red on one side, and green on the other. The LEDs are useful for diagnosing start-up issues, and for determining the quality of satellite reception once the system is operating normally. The LEDs may interpreted as follows: Green LED steadily lit during and after start-up indicates failure to initialize the sign; Red LED steadily lit after start-up indicates failure to initialize the satellite modem; Both red and green steadily lit after start-up indicates failure to initialize the on-board GPS and/or compass components (the dual-sided LED may appear orange when both red and green portions are lit together); and Red and green LEDs alternating on and off for ten seconds at startup indicates failure to read the system's initialization file.

Once the initialization sequence has completed, the red LED may indicate satellite reception strength on a scale of 0 to 5 as follows: Signal strength 0 (The red LED is essentially off, but flickers on instantaneously once approximately every four seconds); Signal strength 1 (The red LED appears mostly off, but flashes on briefly approximately once per second); Signal strength 2 (The red LED flashes on approximately twice per second); Signal strength 3 (The red LED appears to be flashing on and off rapidly); Signal strength 4 (The red LED appears mostly on, but flashes off briefly approximately twice per second); Signal strength 5 (The red LED is essentially lit, but flickers off instantaneously once per second). Note that signal strength of 3 or better may be required for satellite-based communications to take place. It may be normal for satellite reception to vary in and out of this usable range over time, and if signal strength is intermittently below 3, messages may be queued for processing when usable signal strength is recovered. If it appears, however, that satellite signal strength is below 3 most of the time, the user should check for overhead and/or adjacent obstructions that partially block Dynamic Sign Platform 140's view of the sky, and correct any such conditions. A clear view of the sky may minimize any latency in delivering messages to the sign via satellite communications.

### Additional Embodiments

Aspects of various additional embodiments are described below. Various combinations of these and other aspects are contemplated as understood by one of skill in the art.

### Aspects Relating to Accessing Sign Status and Modifying Sign Message

Signs may be controlled using various means. One such means includes a web browser or computer application operating on a computing device (e.g., desktop computer, laptop computer, mobile phone, and others). The web browser or application may include a window that displays a user interface. For example, the web browser may display the user interface as a webpage.

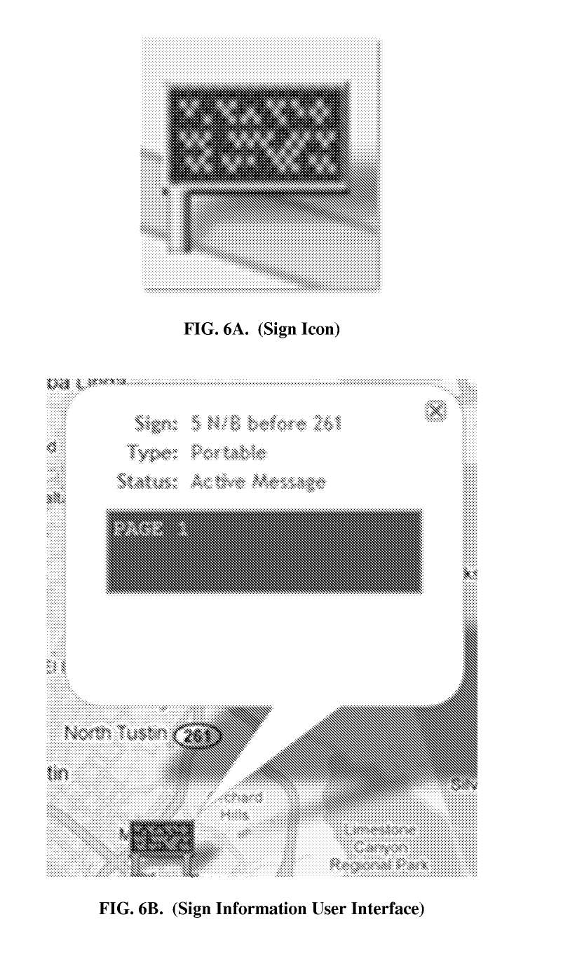

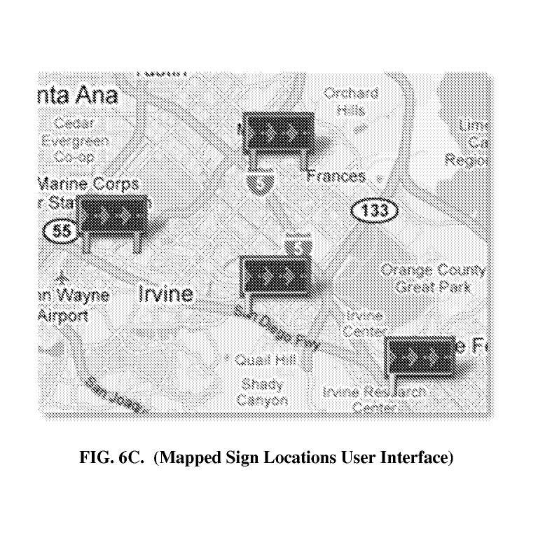

A Google maps interface, or other interface, may be used to display locations of signs (see FIG. 6C for an example map). A user may click and drag the map; scroll in 4 directions; zoom in and out; and select between several different map views, like “Map”, “Satellite”, and “Terrain”.

Various icons (see FIG. 6A) may be used on the map. For example, a one color icon may represent a stationary sign; and another color icon may represent a portable sign. When a sign is selected an icon may have a color border. Additional colors and designs may have different meanings: Message on sign; There is no message on the sign; There is a message pending (the message has been sent to the sign, but a confirmation from the sign has not been received yet; Blank sign (Low Power Mode); Unknown location (Runner is transmitting blank or zero latitude/longitude coordinates; Warning (Location reported by Runner does not match location in Sign record); Error (invalid/corrupt message or error code received from Runner)

A user may obtain more information about a sign (see FIG. 6B) by hovering a cursor or otherwise direct a selection feature of the computing device over any of a sign, and a bubble may pop up to indicate the Sign's name, type, status, and give a display of the current message. If a sign has a sequence of multiple pages of messages, continuing to hover over the sign may display the sequence of messages.

A signs message may be change by following various steps. For example, a user may select and unselect signs in two ways: (1) by clicking on the sign icon on the map to toggle selection on and off, or (2) by clicking to select a sign in the list of signs (on the left side of the RAN control screen). A user may select multiple signs in several ways: by clicking several sign icons in turn on the map; by using CTRL+click to click several signs from the list of signs; by using SHIFT+click to select a series of signs from the list of signs; or by using the pull-down shortcut feature on the bottom left to select a large number of signs.

A user may type a message in the message field. Constraints may be applied to the message field depending on signs with different text capacities, (e.g., smallest maximum number of characters, lines, and pages). To add a message for multiple pages, a radio button may be clicked to the right of the message field, and enter text in the same way as the first page of the message.

A user may then click a send button, and the message may begin transmitting to the sign(s). All of the selected sign icons may display a series of arrows while the message is being transmitted. When the message has been transmitted, the sign icons may return to normal, and hovering over each icon may show the new message.

A selection of the sign and clicking the “Blank” button may turn off a sign's message and put the sign in Low Power Mode. After displaying the message transmission arrows, the icon may then include a letter “z” on a color circle (or any other indicator), indicating it's now in Low Power Mode.

Clicking a “Poll” button with a sign selected sends a poll request to the sign, which retrieves the sign's current message, and confirms its geographic placement on the map. This tool may be used when setting up or relocating a sign, and may be used to determine when a sign's movement is authorized or unauthorized.

### Aspects Relating to Implementation of Server in One Embodiment

In accordance with various aspects, the Control Platform 130 may include a server that may support the following: Maintain sign data: Dynamic Sign Platform 140 ID number, make, model, portable/stationary, unique name within customer's universe, Iridium Terminal ID Number, Cellular SIM Card Number, current state (blanked/not-blanked), message parameters posted, location, and heading; Maintain operator data: name, password, time zone, sign assignment; Formulate, format, and send outgoing messages; Receive, parse, and process contents of incoming messages; and Once every 24 hours (or as set in the sign record), send a Poll Request to every sign, which can also be disabled on a per-sign basis; Maintain a log of all messages to and from signs.

The mechanism to transport messages from the server to the Dynamic Sign Platform 140 is via one of two communications methods: Cellular, or Satellite. Use of cellular may connect to the cellular modem embedded in the Dynamic Sign Platform 140 via a pre-determined IP Address and Port, provided by the cellular carrier. A message may be transmitted over this connection. The connection may be kept open to receive any response. In addition, a server may be listening on a pre-determined IP Address and Port, for messages initiated by the Dynamic Sign Platform 140. Responses to these messages may be sent by the server over the same open connection.

Use of satellite may be configured to send messages to the Iridium gateway by either of two methods: Direct IP and e-mail. Messages sent by Direct IP may be sent by connecting to a pre-determined IP Address and Port, provided by Iridium. Messages sent by e-mail may be sent to Iridium's designated address. To direct a message to a specific Dynamic Sign Platform 140, the subject line may contain the IMEI (International Mobile Equipment Identification) which specifies the unique Iridium modem in the Dynamic Sign Platform 140.

Transmission between the server of the Control Platform 130 and other platforms (e.g., the Dynamic Sign Platform 140) may include the following procedure: Server initiates the transmission of a message. The message is entered into a queue in the database on the server, with a status of “P” (Processing). An independent process running on the server (the “queue daemon”) is responsible for maintaining the message queue and handling error recovery and failover, to ensure reliability and independence from the server's user interface. Thus, if the user session is interrupted before the message is sent, the queue daemon may still be running and ensure that the message is sent. The queue daemon may attempt to connect to the primary interface defined for the sign. If the primary interface is cellular, the queue daemon may attempt a direct TCIP/IP connection to the IP address assigned to the sign's cellular modem. If the primary interface is satellite (via Direct IP), the queue daemon may attempt to connect to the Iridium GSS (ground station) to relay the message. If the primary interface is satellite (via Email), the queue daemon may attempt to send an e-mail to the Iridium GSS to relay the message. If the connection and transmission of the message succeeds, then the queue may be updated to show this message with a status of “T” (Transmitted), the event log may be updated to show the message has been successfully sent, and the server may wait for a response from the Platform 140. If the connection and/or transmission of the message fails, then the queue daemon may set the queue status for the message to “N” (Not Transmitted) and update the event log with the reason for the failure. The queue deamon may then wait 10 seconds (delay can be changed by setting the error_retry_delay system setting), and attempt the connection again. The previous step(s) may be repeated until the connection and transmission succeeds, up to a maximum of 3 retries (error_retries system setting). NOTE: certain errors (such as the cellular modem not being provisioned) may not trigger a retry, but may proceed immediately to failover. If the connection and transmission does not succeed after the maximum number of retries, then the queue daemon may immediately invoke the failover protocol.

Each sign is defined with a primary, secondary, and tertiary interface. The primary interface is required; the secondary and tertiary interfaces are optional. Each interface provides for communication to the sign using a different method. Valid interface methods include cellular, satellite via Direct IP, satellite via E-mail, and Loopback (for internal testing; no message is sent and the system generates its own responses). Additional interfaces may be defined by a system administrator; for example, two different cellular carriers may be utilized, or a backup GSS could be assigned to an interface. In the event that communications fail using the primary interface, the transmission may be attempted using the secondary interface, if it has been defined. If the secondary interface fails as well, then the third interface (if defined) may be attempted according to the same process. If all available interfaces have been attempted and failed, then the queue daemon may set the sign status to “Error” with an indication of the source of the error (communications failure). This may cause the sign marker in the User Interface to change from “Pending Message” (moving chevrons) to “Error” (red “X” icon) with the error indicating visible by hovering the mouse over the sign marker on the map. The event log may also indicate the communications failure and provide more detailed information. The queue status remains set at “N” (Not Transmitted) and no further processing may be done on this message.

Response Processing may include the following procedure: Once a message has been successfully transmitted to the Runner, independent daemons for each interface method (cellular, satellite via Direct IP, and satellite via E-mail) may be listening on the server for any response. In addition, the queue daemon may continue to monitor all messages in the queue with a status of “T” (Transmitted) to determine if a response has been received in a timely manner. Note that these daemons all operate asynchronously, i.e. they can process responses from any signs at any time, even if they arrive back in a different order than they were transmitted.

Successful Response. A response coming back from a sign on any interface is matched to the original transmission in the queue by the sign's unique identifier (IP Address for cellular, IMEI for satellite) and a unique sequence number assigned to the transmission when it was sent. If the response indicates success (e.g. the message was successfully posted to the sign), then the queue status is set to “S” (Success) and the event log updated to indicate a successful response received. In addition, the sign record may be updated appropriately, indicating the current sign status (Active Message, Blank, or Low Power Mode), currently-displayed message, and current latitude, longitude, and heading reported by the Runner. This, in turn, may cause the sign display in the User Interface to be updated, causing the sign marker to change from “Pending Message” (moving chevrons) to the appropriate display (e.g. showing a message or a blank sign). Hovering the mouse over the sign marker on the map may show details, including the current message on the sign. If the heading or position of the sign have significantly changed from their expected values as stored in the sign record, the sign marker may indicate a warning (yellow “!” icon) and details may appear when hovering over the sign marker.

Unexpected Response. A response coming in that: Does not match any sign in the database, or Does not match any sequence number transmitted for a sign, or Matches a sequence number that has already received a response, or Matches a sequence number that was sent using a different interface may be considered to be an “unexpected response” and may be logged as such in the event log. Unexpected responses may not be processed. This is a security measure to reduce the probability of spoofing response messages.

Error Response. If a response is received from the Runner that indicates an error condition, then the queue daemon may set the queue status of the message to “E” (Error) and it may be processed.

No Response (Timeout). If no response is received by the sign within 60 seconds (or as set by the xmit_timeout system setting), then the queue daemon may do the following: For cellular transmissions, proceed to error recovery. For satellite transmissions, it is possible that the messages is still in the GSS queue waiting to be retrieved by the satellite transceiver in the Runner. In this case it is possible to send a message to the GSS telling it to send a “Ring Alert” to the satellite transceiver, prompting it to retrieve the waiting message. So for satellite transmissions that have timed out, the queue daemon may “ping” the Runner by sending a Ring Alert request to the GSS (via Direct IP or via E-mail). If no response has been received within 60 seconds following the ping (or as set by the ping_timeout system setting), then re-send the ping. Do this step up to 3 times (or as set by the ping_retries system setting). If no response after 3 tries, proceed to error recovery (below).

Dynamic Sign Platform 140 Processing. Dynamic Sign Platform 140 may receive and respond to messages sent over either the cellular or satellite data link at all times. When a message is received over one data link or the other, Dynamic Sign Platform 140 may store the link on which the message was received as the current “default” link. Runner may respond to messages via the same communications link on which the message was received. Should the need arise for Dynamic Sign Platform 140 to autonomously send a message to Control, as typically only occurs at power-up, or if Theft Detection logic has been triggered by unexpected movement of a sign, then Runner may use the current “default” link to send a message to Control over the data link that was last used. Dynamic Sign Platform 140 considers the cellular data link to be the “default” link at power-up. If the cellular link fails to initialize successfully at power-up, then Runner may attempt to send its initial power-up message to Control via the satellite data link instead.

In the event of a response from the Runner that indicates an error condition, the original message may be re-sent. NOTE: certain errors may not trigger a re-send. These are errors that are not likely to be transient, which would yield the same result if the message were re-sent. In the event of no response being received from the Runner within the specified timeout period (and following unsuccessful pings if sent via satellite), the original message may be re-sent. The message may be re-sent up to 3 times (or as set by the xmit_retries system setting) until a successful response is received. If no response has been received after 3 retries, then the queue daemon may set the sign status to “Error” with an indication of the source of the error (timeout or error response). This may cause the sign marker in the User Interface to change from “Pending Message” (moving chevrons) to “Error” (red “X” icon) with the error indicating visible by hovering the mouse over the sign marker on the map. The event log may also indicate the error and provide more detailed information. The queue status may be changed to “F” (Failure) and no further processing may be done on this message.

### Aspects Relating to Functionality of Signs

In one aspect signs may communication with each other using various means, including terrestrial (e.g., cellular) communication pathways, satellite communication pathways, web-based communication pathways, or other communication pathways known by one of skill in the art.

In another aspect, one sign may receive multiple messages, where at least some of the messages are intended for different signs. The sign may transmit other messages to other signs, and may determine which message is intended for that sign (e.g., using header information or content of message).

In another aspect, one sign may receive multiple messages intended for display by that sign at different time periods or under different scenarios (e.g., when weather, traffic or other conditions change as sensed by the sign).

In another aspect, signs may collect and report local data (e.g., weather, traffic, and other environmental conditions). Various sensors may be used to collect the data, including atmospheric sensors (e.g., wind, temperature, moisture and other atmospheric conditions), image sensors, directional orientation sensors, inertial sensors, and other sensors.

### Summary Aspects

Aspects of the disclosure may provide a system, method and computer program product comprising various functional features, including functions that: identify a first indication of a first selection identifying a first remote sign from among a plurality of other signs; identify a first request associated with the first remote sign; cause first transmit data to be transmitted to the first remote sign based on the first selection and the first request; and identify first response data transmitted from the first remote sign, wherein the first response data relates to the first transmit data.

The functional features may also cause a user interface operated by a user to display a representation of the first response data, wherein the first response data indicates that the first remote sign is displaying the first message.

The functional features may cause the user interface to display an indication that the first data has been transmitted to the first remote sign prior to causing the user interface to display the representation of the first response data indicating that the first remote sign is displaying the first message.

The first selection may be a user selection of a first icon from a map of icons corresponding to the first remote sign and the plurality of other signs, wherein the map is displayed on the user interface.

The first request may include first message data representing a first message, and the first transmit data may include a representation of the first message data. The functional features may identify one or more message constraints associated with the first remote sign; and cause the first message data to be modified based on the one or more message constraints, wherein the first transmit data includes a representation of the modified first message data, wherein the one or more message constraints specify a maximum number of characters that the first remote sign can display, wherein the first message data specifies a first number of characters that is greater than the maximum number of characters, and wherein the first message data is modified to specify the maximum number of characters

The functional features may identify one or more message constraints associated with the first remote sign; and cause the first message data to be modified based on the one or more message constraints, wherein the one or more message constraints specify an available format type selected from the group of format types consisting of a maximum number of lines per page the first remote sign can display, a maximum number of pages the first remote sign can display, a maximum character width of each line the first remote sign can display, whether the first remote sign is capable of displaying streaming text, whether the first remote sign is capable of displaying colors, and whether the first remote sign is capable of displaying animation, wherein the first message data specifies a first format, and wherein the first message data is modified to specify the available format type.

The first transmit data may include a request for status information. The first response data may specify an orientation of the first sign and both latitude and longitude position coordinates of the first sign, or may specify one or more atmospheric conditions at or near the first sign, including one or more of temperature, barometric pressure, moisture, and wind power and direction.

The first request may specify requested information associated with the first remote sign, and the functional features may further: determine whether the data source has stored information specifying the requested information; determine, if the data source has the stored information specifying the requested information, whether the stored information is expired; upon determining that the stored information is not expired, cause the stored information to be transmitted; upon determining that the stored information is expired, cause the first transmit data to be transmitted to the first remote sign, wherein the first transmit data includes a representation of the first request; identify, from the first response data, response information specifying the requested information; cause the data source to update the stored information with the response information; and cause an expiration time associated with the stored information to update based on the updating of the stored information with the response information.

The first request may include a first data object value, and the functional features may store the data object value in the data source; cause the first transmit data to be transmitted to the first remote sign, wherein the first transmit data includes a representation of the data object value; identify, from the first response data, whether the first remote sign completed an update of a data object using the first data object value; and cause, if the first remote sign did not complete an update of the data object using the first data object value, the data source to remove the stored data object value.

The functional features may identify a second indication of a second selection identifying a second remote sign from among the plurality of other signs; cause the first transmit data to be transmitted to the first remote sign based on the first selection; identify second response data transmitted from the second remote sign, wherein the second response data relates to the first transmit data; and cause the user interface to display a representation of the second response data.

The functional features may identify second data transmitted from the first remote sign, wherein the second data indicates that the sign is moving; determine whether the movement of the sign is authorized or unauthorized based on data stored in the data source that indicates whether the sign is scheduled to be moved; and upon determining that the movement of the sign is unauthorized, causing an alert signal to be transmitted to a predefined user device.

A system may include a communication and control platform coupled to the first remote sign that comprises: a GPS tracking component configured to determine latitude and longitude of the first remote sign; a compass configured to determine an orientation of the first remote sign; a satellite network transceiver configured to receive the first transmit data from a satellite; a terrestrial network transceiver, wherein the first response data may be transmitted using the terrestrial network transceiver through the terrestrial network or the satellite network transceiver through the satellite network; and a processing component configured to process the first transmit data and to identify the first response data.

It is to be understood that any device compliant with NTCIP may be used with any of the aspects disclosed herein. Accordingly, use of such devices form alternative embodiments to those expressly disclosed herein.

It is to be further understood that aspects of this disclosure may be adapted to control any sign, regardless of its protocol standard (e.g., NTCIP).

### Additional Aspects

It is understood that the specific order components disclosed herein are examples of exemplary approaches. Based upon design preferences, it is understood that the specific order components may be rearranged, and/or components may be omitted, while remaining within the scope of the present disclosure unless noted otherwise. The previous description of the disclosed embodiments is provided to enable any person skilled in the art to make or use the present disclosure. Various modifications to these embodiments may be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The disclosure is not intended to be limited to the aspects shown herein, but is to be accorded the full scope consistent with the specification and drawings, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In accordance with certain aspects of the present invention, one or more of the process steps described herein may be stored in memory as computer program instructions. These instructions may be executed by a digital signal processor, an analog signal processor, and/or another processor, to perform the methods described herein. Further, the processor(s), the memory, the instructions stored therein, or a combination thereof may serve as a means for performing one or more of the method steps described herein.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Any processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present disclosure. Various modifications to these embodiments may be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein. It is intended that the following claims and their equivalents define the scope of the invention.

Aspects of the present invention are typically carried out in or resident on a computing network. The computing network generally includes computer hardware components such as servers, monitors, I/O devices, network connection devices, as well as other associated hardware. In addition, the aspects and features described below may include one or more application programs configured to receive, convert, process, store, retrieve, transfer and/or export data and other content and information. As an example, these aspects and features may include one or more processors that may be coupled to a memory space comprising SRAM, DRAM, Flash and/or other physical memory devices. Memory space may be configured to store an operating system (OS), one or more application programs, such as a UI program, data associated with the pertinent aspect or feature, applications running on processors in the device, user information, or other data or content. The various aspects and features of the present invention may further include one or more User I/O interfaces, such as keypads, touch screen inputs, mice, Bluetooth devices or other I/O devices. In addition, the certain aspects and features may include a cellular or other over the air wireless carrier interface, as well as a network interface that may be configured to communicate via a LAN or wireless LAN (WiLAN), such as a Wi-Fi network. Other interfaces, such as USB or other wired interfaces may also be included.

As used herein, computer program products comprising computer-readable media including all forms of computer-readable medium except, to the extent that such media is deemed to be non-statutory, transitory propagating signals.

While various embodiments of the present invention have been described in detail, it may be apparent to those skilled in the art that the present invention can be embodied in various other forms not specifically described herein.

1. A system configured to control one or more electronic signs remotely via one or more communication technologies, the system comprising:
one or more processing components operable to:
identify a first indication of a first selection identifying a first remote sign from among a plurality of other signs;
identify a first request associated with the first remote sign;
cause first transmit data to be transmitted to the first remote sign based on the first selection and the first request; and
identify first response data transmitted from the first remote sign, wherein the first response data relates to the first transmit data.

2. The system of claim 1, wherein the one or more processing components are further operable to:
cause a user interface operated by a user to display a representation of the first response data, wherein the first response data indicates that the first remote sign is displaying the first message.

3. The system of claim 2, wherein the one or more processing components are further operable to:
prior to causing the user interface to display the representation of the first response data indicating that the first remote sign is displaying the first message, cause the user interface to display an indication that the first data has been transmitted to the first remote sign.

4. The system of claim 2, wherein the first selection is a user selection of a first icon from a map of icons corresponding to the first remote sign and the plurality of other signs, wherein the map is displayed on the user interface.

5. The system of claim 2, wherein the first request includes first message data representing a first message, and wherein the first transmit data includes a representation of the first message data.

6. The system of claim 5, wherein the one or more processing components are further operable to:
identify one or more message constraints associated with the first remote sign; and
cause the first message data to be modified based on the one or more message constraints, wherein the first transmit data includes a representation of the modified first message data, wherein the one or more message constraints specify a maximum number of characters that the first remote sign can display, wherein the first message data specifies a first number of characters that is greater than the maximum number of characters, and wherein the first message data is modified to specify the maximum number of characters

7. The system of claim 5, wherein the one or more processing components are further operable to:
identify one or more message constraints associated with the first remote sign; and
cause the first message data to be modified based on the one or more message constraints,
wherein the one or more message constraints specify an available format type selected from the group of format types consisting of a maximum number of lines per page the first remote sign can display, a maximum number of pages the first remote sign can display, a maximum character width of each line the first remote sign can display, whether the first remote sign is capable of displaying streaming text, whether the first remote sign is capable of displaying colors, and whether the first remote sign is capable of displaying animation,
wherein the first message data specifies a first format, and
wherein the first message data is modified to specify the available format type.

8. The system of claim 2, wherein the first transmit data includes a request for status information.

9. The system of claim 2, wherein the first response data specifies an orientation of the first sign and both latitude and longitude position coordinates of the first sign.

10. The system of claim 2, wherein the first response data specifies one or more atmospheric conditions at or near the first sign, including one or more of temperature, barometric pressure, moisture, and wind power and direction.

11. The system of claim 1, further comprising a data source, wherein the first request specifies requested information associated with the first remote sign, and wherein the one or more processing components are further operable to:
determine whether the data source has stored information specifying the requested information;
determine, if the data source has the stored information specifying the requested information, whether the stored information is expired;
upon determining that the stored information is not expired, cause the stored information to be transmitted;
upon determining that the stored information is expired, cause the first transmit data to be transmitted to the first remote sign, wherein the first transmit data includes a representation of the first request;
identify, from the first response data, response information specifying the requested information;
cause the data source to update the stored information with the response information; and
cause an expiration time associated with the stored information to update based on the updating of the stored information with the response information.

12. The system of claim 1, further comprising a data source, wherein the first request includes a first data object value, and wherein the one or more processing components are further operable to:
cause the data source to store the data object value;
cause the first transmit data to be transmitted to the first remote sign, wherein the first transmit data includes a representation of the data object value;
identify, from the first response data, whether the first remote sign completed an update of a data object using the first data object value; and
cause, if the first remote sign did not complete an update of the data object using the first data object value, the data source to remove the stored data object value.

13. The system of claim 2, wherein the one or more processing components are further operable to:
identify a second indication of a second selection identifying a second remote sign from among the plurality of other signs;
cause the first transmit data to be transmitted to the first remote sign based on the first selection;
identify second response data transmitted from the second remote sign, wherein the second response data relates to the first transmit data; and
cause the user interface to display a representation of the second response data.

14. The system of claim 2, further comprising:
a communication platform coupled to the first remote sign, wherein the communication platform comprises:
a GPS tracking component configured to determine latitude and longitude of the first remote sign;
a compass configured to determine an orientation of the first remote sign;
a satellite network transceiver configured to receive the first transmit data from a satellite;
a terrestrial network transceiver, wherein the first response data may be transmitted using the terrestrial network transceiver through the terrestrial network or the satellite network transceiver through the satellite network; and
a processing component configured to process the first transmit data and to identify the first response data.

15. The system of claim 2, further comprising a data source, wherein the one or more processing components are further operable to:
identify second data transmitted from the first remote sign, wherein the second data indicates that the sign is moving;
determine whether the movement of the sign is authorized or unauthorized based on data stored in the data source that indicates whether the sign is scheduled to be moved; and
upon determining that the movement of the sign is unauthorized, causing an alert signal to be transmitted to a predefined user device.

16. A computer-program product for controlling electronic signs remotely via one or more communication technologies, the computer-program product comprising a non-transitory computer-readable medium having instructions thereon, the instructions comprising code programmed to:
identify a first indication of a first selection identifying a first remote sign from among a plurality of other signs;
identify a first request associated with the first remote sign;
cause first transmit data to be transmitted to the first remote sign based on the first selection and the first request;
identify first response data transmitted from the first remote sign, wherein the first response data relates to the first transmit data;
cause a user interface operated by a user to display a representation of the first response data, wherein the first response data indicates that the first remote sign is displaying the first message; and
prior to causing the user interface to display the representation of the first response data indicating that the first remote sign is displaying the first message, cause the user interface to display an indication that the first data has been transmitted to the first remote sign.

17. The computer-program product of claim 16, the instructions further comprising code programmed to:
identify one or more message constraints associated with the first remote sign, wherein the first request includes first message data representing a first message, and wherein the first transmit data includes a representation of the first message data; and
cause the first message data to be modified based on the one or more message constraints, wherein the first transmit data includes a representation of the modified first message data;
identify second data transmitted from the first remote sign, wherein the second data indicates that the sign is moving;
determine whether the movement of the sign is authorized or unauthorized based on data stored in the data source that indicates whether the sign is scheduled to be moved;
upon determining that the movement of the sign is unauthorized, causing an alert signal to be transmitted to a predefined user device;
identify a second indication of a second selection identifying a second remote sign from among the plurality of other signs;
cause the first transmit data to be transmitted to the first remote sign based on the first selection;
identify second response data transmitted from the second remote sign, wherein the second response data relates to the first transmit data; and
cause the user interface to display a representation of the second response data, wherein the first selection is a user selection of a first icon from a map of icons corresponding to the first remote sign and the plurality of other signs, wherein the map is displayed on the user interface, and wherein the first response data specifies an orientation of the first sign and both latitude and longitude position coordinates of the first sign.

18. The computer-program product of claim 16, the instructions further comprising code programmed to:
determine whether a data source has stored information specifying requested information from the first request;
determine, if the data source has the stored information specifying the requested information, whether the stored information is expired;
upon determining that the stored information is not expired, cause the stored information to be transmitted;
upon determining that the stored information is expired, cause the first transmit data to be transmitted to the first remote sign, wherein the first transmit data includes a representation of the first request;
identify, from the first response data, response information specifying the requested information;
cause the data source to update the stored information with the response information; and
cause an expiration time associated with the stored information to update based on the updating of the stored information with the response information;
cause the data source to store a data object value including in the first request;
cause the first transmit data to be transmitted to the first remote sign, wherein the first transmit data includes a representation of the data object value;
identify, from the first response data, whether the first remote sign completed an update of a data object using the first data object value; and
cause, if the first remote sign did not complete an update of the data object using the first data object value, the data source to remove the stored data object value.

19. A method for controlling electronic signs remotely via one or more communication technologies, the method comprising the following steps:
identify a first indication of a first selection identifying a first remote sign from among a plurality of other signs;
identify a first request associated with the first remote sign;
cause first transmit data to be transmitted to the first remote sign based on the first selection and the first request;
identify first response data transmitted from the first remote sign, wherein the first response data relates to the first transmit data;
cause a user interface operated by a user to display a representation of the first response data, wherein the first response data indicates that the first remote sign is displaying the first message; and
prior to causing the user interface to display the representation of the first response data indicating that the first remote sign is displaying the first message, cause the user interface to display an indication that the first data has been transmitted to the first remote sign,
wherein at least one of the above steps is performed by at least one processing component of a computing device.

20. The method of claim 19, further comprising the following steps:
identify one or more message constraints associated with the first remote sign, wherein the first request includes first message data representing a first message, and wherein the first transmit data includes a representation of the first message data; and
cause the first message data to be modified based on the one or more message constraints, wherein the first transmit data includes a representation of the modified first message data;
identify second data transmitted from the first remote sign, wherein the second data indicates that the sign is moving;
determine whether the movement of the sign is authorized or unauthorized based on data stored in the data source that indicates whether the sign is scheduled to be moved;
upon determining that the movement of the sign is unauthorized, causing an alert signal to be transmitted to a predefined user device;
identify a second indication of a second selection identifying a second remote sign from among the plurality of other signs;
cause the first transmit data to be transmitted to the first remote sign based on the first selection;
identify second response data transmitted from the second remote sign, wherein the second response data relates to the first transmit data; and
cause the user interface to display a representation of the second response data, wherein the first selection is a user selection of a first icon from a map of icons corresponding to the first remote sign and the plurality of other signs, wherein the map is displayed on the user interface, and wherein the first response data specifies an orientation of the first sign and both latitude and longitude position coordinates of the first sign;
determine whether a data source has stored information specifying requested information from the first request;
determine, if the data source has the stored information specifying the requested information, whether the stored information is expired;
upon determining that the stored information is not expired, cause the stored information to be transmitted;
upon determining that the stored information is expired, cause the first transmit data to be transmitted to the first remote sign, wherein the first transmit data includes a representation of the first request;
identify, from the first response data, response information specifying the requested information;
cause the data source to update the stored information with the response information; and
cause an expiration time associated with the stored information to update based on the updating of the stored information with the response information;
cause the data source to store a data object value including in the first request;
cause the first transmit data to be transmitted to the first remote sign, wherein the first transmit data includes a representation of the data object value;
identify, from the first response data, whether the first remote sign completed an update of a data object using the first data object value; and
cause, if the first remote sign did not complete an update of the data object using the first data object value, the data source to remove the stored data object value.
